(19) United States
(12) Patent Application Publication
(10) Pub. No.: US 2023/0378524 A1
(43) Pub. Date: Nov. 23, 2023

(54) SULFIDE-BASED SOLID ELECTROLYTE FOR ALL-SOLID LITHIUM SECONDARY BATTERY AND METHOD FOR PREPARING SULFIDE-BASED SOLID ELECTROLYTE

(71) Applicant: POSCO JK SOLID SOLUTION CO., LTD., Yangsan-si, Gyeongsangnam-do (KR)

(72) Inventors: Tae Heung KIM, Busan (KR); Duck Ki YOON, Busan (KR); Hyung Sik LIM, Busan (KR)

(73) Assignee: POSCO JK SOLID SOLUTION CO., LTD., Yangsan-si, Gyeongsangnam-do (KR)

(21) Appl. No.: 18/029,055

(22) PCT Filed: Sep. 28, 2021
(86) PCT No.: PCT/KR2021/013256

§ 371 Date: Mar. 28, 2023

(30) Foreign Application Priority Data
Sep. 28, 2020 (KR) 10-2020-0126177
Jun. 21, 2021 (KR) 10-2021-0080338

(51) Int. Cl. H01M 10/0562; H01M 10/052; C01B 25/14

(52) U.S. Cl. CPC H01M 10/0562; H01M 10/052; C01B 25/14; H01M 2300/008; C01P 2002/54; C01P 2006/40

(57) ABSTRACT

The present invention relates to a sulfide-based solid electrolyte for an all-solid lithium secondary battery, and to a method for preparing the sulfide-based solid electrolyte. The present invention has an effect of providing a sulfide-based solid electrolyte that has excellent stability with respect to lithium metal and has excellent ion conductivity, while having high crystallinity. The present invention has an effect of providing a method for preparing a sulfide-based solid electrolyte that has excellent stability with respect to lithium metal and has excellent ion conductivity, while having high crystallinity even when heat-treated at a low temperature.

### TECHNICAL FIELD

The present invention relates to a sulfide-based solid electrolyte for all-solid lithium secondary batteries and a method of preparing the sulfide-based solid electrolyte, and more particularly to a crystalline sulfide-based solid electrolyte that has excellent ion conductivity, low electronic conductivity and excellent stability with respect to a lithium metal while having high crystallinity even when heat-treated at a relatively low temperature.

### BACKGROUND ART

Recently, the use of lithium secondary batteries is expanding from a power source for small mobile devices to a power source for medium and large-sized electric vehicles (xEV) and power storage systems (ESS). In particular, interest in electric vehicles, which are eco-friendly vehicles, is very high, and major automakers around the world are recognizing eco-friendly electric vehicles as a next-generation growth technology and accelerating technology development thereof.

Battery specifications required for electric vehicles may include high power density capable of rapid charging, high energy density per weight/volume, price, safety, etc. In particular, in electric vehicles which are devices that people directly board and control, securing safety during operation and accidents is the most important requirement. In the case of the Model S as a commercial model of Tesla which is a representative electric vehicle company in the United States, a number of cases where a fire broke out while driving and burned down were announced through the media. Thereby, the development of an all-solid-state battery with high safety is required.

An all-solid-state battery, which is a battery in which a liquid of an electrolyte between positive and negative electrodes of a battery is replaced with a solid, does not include flammable organic solvents, so the risk of fire or explosion is low even if an internal short circuit occurs, and the size of the battery can be reduced. In addition, it has excellent manufacturing cost and productivity, and can achieve high voltage when stacked in series within a cell. Further, since ions other than Li ions in such a solid electrolyte do not move, side reactions due to the movement of anions do not occur, leading to improvements in safety and durability. Such an all-solid-state battery can increase safety compared to existing lithium secondary batteries.

However, since an electrolyte, in which lithium ions move, of an all-solid-state battery is solid, the all-solid-state battery has lower ionic conductivity compared to the case where a liquid electrolyte is used, resulting in low output and short lifespan. Thereby, the global industry has begun to search for electrolyte materials for all-solid-state batteries that can increase ionic conductivity as much as possible, and as a candidate, a sulfide-based solid electrolyte with excellent ionic conductivity is of great interest.

### DISCLOSURE

### Technical Problem

Conventionally, an amorphous sulfide-based solid electrolyte or a crystalline sulfide-based solid electrolyte has been used as a sulfide-based solid electrolyte. Since the amorphous sulfide-based solid electrolyte does not require high crystallinity, manufacturing is possible even when a heat treatment temperature during manufacture is as low as 300° C. or less, thereby reducing process costs.

However, since the amorphous sulfide-based solid electrolyte has high reactivity with a lithium metal, side reactions continuously increase during the charging/discharging of an all-solid-state battery, making it difficult to form a stable solid electrolyte film.

Thereby, efforts are being made to use a crystalline sulfide-based solid electrolyte, which can form a stable solid electrolyte film through reaction with a lithium metal, as a solid electrolyte for an all-solid-state battery.

However, a crystalline sulfide-based solid electrolyte requires heat treatment at a temperature of 500° C. or higher to achieve high crystallinity. To perform heat treatment at 500° C. or higher, a solid electrolyte composition stable at high temperature and complicated heat treatment equipment for preventing sulfur vacancy generated during a heat treatment process are required.

Therefore, the present invention has been made in view of the above problems, and it is one object of the present invention to provide a crystalline sulfide-based solid electrolyte having excellent stability with respect to a lithium metal while having high crystallinity even when heat-treated at a relatively low temperature. It is another object of the present invention to provide a sulfide-based solid electrolyte that has low electronic conductivity while having excellent ionic conductivity.

It will be understood that technical problems of the present invention are not limited to the aforementioned problems and other technical problems not referred to herein will be clearly understood by those skilled in the art from disclosures below.

### Technical Solution

In accordance with an aspect of the present invention, the above and other objects can be accomplished by the provision of a sulfide-based solid electrolyte,
the sulfide-based solid electrolyte being a Li₂S—P₂S₅-MCl-MX′ (X′ is a halogen other than Cl)-based sulfide-based solid electrolyte and
the sulfide-based solid electrolyte including lithium element (Li), sulfur element (S), phosphorus element (P) and halogen element (X),
wherein the halogen element (X) is chlorine element (Cl) and at least one halogen, other than Cl, selected from the group consisting of fluorine element (F), bromine element (Br), iodine element (I) and combinations thereof, and
a molar ratio (Li/P) of lithium element (Li) to phosphorus element (P) is 5 or more and less than 6.2, a sum of a molar ratio (S/P) of sulfur element (S) to phosphorus element (P) and a molar ratio (X/P) of halogen element (X) to phosphorus element (P) is 6 to 6.5, and a molar ratio (X/S) of halogen element (X) to sulfur element (S) is 0.25 to 0.30.

In addition, the present invention provides a sulfide-based solid electrolyte having an electronic conductivity of 1.4×10⁻⁵ mS/cm or less.

In addition, the present invention provides a sulfide-based solid electrolyte including chlorine and iodine as halogens.

In accordance with another aspect of the present invention, there is provided a method of preparing a sulfide-based solid electrolyte, the method including:
a) a step of mixing a raw material including a lithium-containing compound, a phosphorus-containing compound, and a halogen element-containing compound while grinding the same; and
b) a step of heat-treating a pulverized product, obtained by the step a), at a temperature of 450° C. or higher and lower than 500° C. under a vacuum or inert atmosphere.

### Advantageous Effects

The present invention provides a sulfide-based solid electrolyte that has high crystallinity, excellent stability with respect to a lithium metal, and excellent ion conductivity, but low electronic conductivity. The present invention has the effect of improving ionic conductivity and lowering electronic conductivity due to addition of a small amount of halogen compound, thereby exhibiting excellent electrochemical properties compared to existing solid electrolytes.

The present invention can provide a sulfide-based solid electrolyte having high lithium ion conductivity by performing heat treatment without addition of H₂S gas at a relatively low temperature of 450° C. or more and less than 500° C. at which sulfur vacancy is minimized.

The present invention can provide a method of preparing a sulfide-based solid electrolyte having excellent stability with respect to a lithium metal and excellent ion conductivity while having high crystallinity even when heat-treated at a low temperature.

The present invention has an advantage in that the possibility of sulfur vacancy due to heat treatment during manufacturing is low, and therefore, there is no need to use H₂S gas used to prevent sulfur vacancy.

### BEST MODE FOR CARRYING OUT THE INVENTION

Now, the present invention will be described in more detail to help understand the present invention. Terms or words used in the specification and the following claims shall not be limited to common or dictionary meanings, and have meanings and concepts corresponding to technical aspects of the embodiments of the present invention so as to most suitably express the embodiments of the present invention.

A crystalline sulfide-based solid electrolyte is prepared using a composition including Li₂S, P₂S₅ and halogenated compounds (LiCl, LiBr, LiI, LiF, etc.). Here, halogen, which is a monovalent anion, is weaker in attracting Li ions than S, which is a divalent anion, so the density of Li ions around a crystal structure lattice is reduced, so Li ions move relatively easily. Lithium-ion conductivity may be improved by increasing the amount of halogen occupying the crystalline lattice of a crystalline sulfide-based solid electrolyte using a method of utilizing such Li ion mobility characteristics.

A sulfur content in a solid electrolyte decreases as much as a halogen compound is increased through substitution or addition, and sulfur vacancy occurs due to heat applied during the manufacturing process of a solid electrolyte, whereby the electronic conductivity in a solid electrolyte increases, resulting in a short circuit inside a battery.

That is, when a halogen content is increased to increase the ionic conductivity of a sulfide-based solid electrolyte, a sulfur content is reduced, resulting in sulfur vacancy, which increases electronic conductivity. However, if the electronic conductivity is high, the inside of a cell may be short-circuited. Therefore, the present inventors developed a sulfide-based solid electrolyte with high ionic conductivity but low electronic conductivity so that a battery can be stably operated.

On the other hand, a related technology tried to prevent sulfur deficiency by introducing H₂S gas in a heat treatment process for producing a solid electrolyte, but when using H₂S gas, there is a problem that safety measures such as a neutralization treatment system should be added.

Accordingly, the present inventors aimed to minimize sulfur vacancy in a sulfide-based solid electrolyte by minimizing the addition of a halogen compound and to provide a sulfide-based solid electrolyte that can be heat-treated without introducing H₂S gas at a relatively low temperature of 450 or more and less than 500° C. and has high lithium ion conductivity.

The present invention provides a sulfide-based solid electrolyte prepared through heat treatment without addition of H₂S gas at a relatively low temperature of 450 to 500° C., wherein the sulfide-based solid electrolyte includes lithium element (Li), sulfur element (S), phosphorus element (P) and halogen element (X), wherein the halogen element (X) includes chlorine element (Cl) and at least one halogen, other than chlorine, selected from the group consisting of fluorine element (F), bromine element (Br), iodine element (I) and combinations thereof. Here, a molar ratio (Li/P) of lithium element (Li) to phosphorus element (P) is 5 or more and less than 6.2, the sum of a molar ratio (S/P) of sulfur element (S) to phosphorus element (P) and a molar ratio (X/P) of halogen element (X) to phosphorus element (P) is 6 to 6.5, preferably 6 to 6.2, and a molar ratio (X/S) of halogen element (X) to sulfur element (S) is 0.25 to 0.30.

The sulfide-based solid electrolyte of the present invention includes preferably chlorine and iodine as halogens and may further include fluorine or bromine. When the sulfide-based solid electrolyte of the present invention includes iodine, a crystallization temperature may be lowered. In addition, the present invention is advantageous in that sufficient ionic conductivity is exhibited when a molar ratio (Cl/P) of chlorine to phosphorus element (P) to a molar ratio (X/P) of halogen to phosphorus element (P) is 0.85 to 0.98.

In the solid electrolyte of the present invention, a molar ratio (X/S) of halogen element (X) to sulfur element (S) is 0.25 to 0.30, so halogen is included in a relatively small amount. Accordingly, a solid electrolyte having high crystallinity and excellent ionic conductivity may be provided even when heat-treated at a relatively low temperature. In addition, since the LiS content in the solid electrolyte of the present invention is relatively high, there is no risk of sulfur loss during firing and, accordingly, there is no need to use H₂S gas, etc. during manufacturing. The solid electrolyte of the present invention has the advantage that sulfur vacancy does not occur even when H₂S gas is not used and as a result, the electronic conductivity of a solid electrolyte is low. Accordingly, there is less short circuit inside a battery. The sulfide-based solid electrolyte of the present invention is characterized by having an electronic conductivity of 1.4×10⁻⁵ mS/cm or less.

In the sulfide-based solid electrolyte of the present invention, a molar ratio (X/S) of halogen element (X) to sulfur element (S) may be 0.265 to 0.275.

In an embodiment of the present invention, the sulfide-based solid electrolyte may be a compound represented by Formula (1) below:

Li_{7-x-y}PS₆₋ₓX_{x+y} Formula (1)

In the formula,

X is Cl and at least one halogen, other than Cl, selected from the group consisting of F, Br, I and combinations thereof,

0.8≤x≤1.5,

0<y≤0.5, and

(x+y)/(6−x) is 0.25 to 0.30.

According to an embodiment of the present invention, a sulfide-based solid electrolyte wherein (x+y)/(6−x) is 0.265 or more and less than 0.3 may be provided.

According to an embodiment of the present invention, a sulfide-based solid electrolyte wherein a molar ratio (X/P) of halogen to phosphorus element (P) is 1.2 to 1.4 may be provided.

In an embodiment of the present invention, the solid electrolyte of the present invention may include the sulfide-based compound of the present invention and may further include other materials or components.

That is, the solid electrolyte may consist of a single phase composed of a crystal phase of a cubic argyrodite-type crystal structure or may consist of a mixed phase containing a crystal phase of a cubic argyrodite-type crystal structure and a crystal phase represented by LiX (X is halogen).

In addition, the other materials may contain a crystal phase represented by Li₂S.

That is, the solid electrolyte of the present invention may be composed of the solid electrolyte of the present invention alone, and the content of the solid electrolyte of the present invention may be 50% by mass or more, preferably 80% by mass or more, more preferably 90% by mass or more of the total electrolyte.

In addition, the solid electrolyte of the present invention may also include unavoidable impurities in an amount of, for example, less than 5% by mass, especially less than 3% by mass which have a little adverse effect on the present invention, in addition to the above materials.

A method of preparing the sulfide-based solid electrolyte of the present invention includes:
a) a step of mixing a raw material including a lithium-containing compound, a phosphorus-containing compound, and a halogen element-containing compound while pulverizing the raw material; and
b) a step of heat-treating a pulverized product, obtained by the step a), at a temperature of 450° C. or higher and lower than 500° C. under a vacuum or inert atmosphere.

Examples of the lithium (Li)-containing compound include lithium compounds such as lithium sulfide (Li₂S), lithium oxide (Li₂O) and lithium carbonate (Li₂CO₃), lithium metal groups, and the like.

Examples of the phosphorus (P)-containing compound include phosphorus compounds and groups such as phosphorus sulfides such as diphosphorus trisulfide (P₂S₃) and diphosphorus pentasulfide (P₂S₅), and the like.

Examples of the sulfur (S)-containing compound include the lithium sulfide or phosphorus sulfide.

The halogen may include fluorine or bromine together with chlorine and iodine.

Examples of the chlorine-containing compound include LiCl, PCl₃, PCl₅, P₂Cl₄, SCl₂, S₂Cl₂, NaCl, BCl₃, and the like.

Examples of the bromine-containing compound include LiBr, PBr₃, S₂Br₂, NaBr, BBr₃, and the like.

Examples of the iodine-containing compound include LiI, PI₃, GeI₄, and the like.

Thereamong, a combination of lithium sulfide, phosphorus sulfide, lithium chloride, and lithium bromide or lithium iodide is preferable.

In the preparation method of the present invention, it is preferable to mix raw materials by means of, for example, a ball mill, a bead mill, a homogenizer, or the like.

In addition, since the raw materials are very unstable in the air, react with moisture to be decomposed and generate hydrogen sulfide gas or are oxidized, it is preferable to set and fire the raw materials in a furnace in an inert gas atmosphere chamber or the like.

The present invention provides an all-solid lithium secondary battery including the sulfide-based solid electrolyte of the present invention. That is, the sulfide-based solid electrolyte of the present invention may be used as a solid electrolyte layer of an all-solid lithium secondary battery, a solid electrolyte mixed with a positive/negative electrode mixture, or the like.

In an embodiment, an all-solid lithium secondary battery may be constituted by forming a layer including a positive electrode, a negative electrode and the solid electrolyte formed between the positive electrode and the negative electrode.

The solid electrolyte of the present invention has excellent stability with respect to a lithium metal and excellent ion conductivity while having high crystallinity, so a stable and efficient all-solid-state lithium secondary battery can be provided.

Here, the layer including the solid electrolyte may be manufactured, for example, by a method of dropping a slurry composed of a solid electrolyte, a binder and a solvent onto a substrate and cutting the same by rubbing with a doctor blade or the like, a method of cutting with an air knife after contacting gas and slurry, a method of forming a coating film by a screen printing method or the like, and then removing a solvent through ustulation, or the like. Alternatively, a powder of a solid electrolyte was made into a green compact by pressing, etc., and then processed to produce a layer.

As a positive electrode material of the all-solid lithium secondary battery of the present invention, a positive electrode material used as a positive electrode active material of a lithium secondary battery may be used without limitation. Examples of the positive electrode active material include a spinel-type lithium transition metal oxide, a lithium transition metal oxide having a layered structure, olivine, and a mixture of two or more thereof.

As a negative electrode material of the all-solid lithium secondary battery of the present invention, a negative electrode material used as a negative electrode active material of a lithium secondary battery may be used without limitation. Examples of the negative electrode active material include carbon-based materials such as artificial graphite, natural graphite, and non-graphitizable carbon (hard carbon). Therefore, the energy density of the all-solid-state lithium secondary battery may be greatly improved by using a carbon-based material as a negative electrode active material together with the solid electrolyte of the present invention as an electrolyte of a lithium secondary battery. In addition, a silicon active material, which is a high-capacity negative electrode material, may be used as the negative electrode active material.

### MODE FOR CARRYING OUT THE INVENTION

Hereinafter, the present invention will be described with an example of the present invention. However, the present invention is not limited thereto, and in describing the present invention, descriptions of functions or components that are already known will be omitted to clarify the gist of the present invention.

### [Comparative Example 1] Preparation of Sulfide-Based Solid Electrolyte Including Chlorine

38.8 g of lithium sulfide (Li₂S) powder, 41.5 g of diphosphorus pentasulfide (P₂S₅) powder and 19.7 g of lithium chloride (LiCl) powder were weighed and pulverized and mixed to prepare a mixed powder. The mixed powder was filled in a container and fired in an electric furnace under argon gas at a firing temperature of 450° C. for 10 hours. Next, a sample was collected to obtain an argyrodite crystalline sulfide-based compound as a powdery solid electrolyte.

All the weighing, the mixing, the heat treatment in an electric furnace, and extraction were conducted under sufficiently dry Ar gas. The composition, lithium ion conductivity and electronic conductivity characteristics of the obtained solid electrolyte are shown in Table 1 below.

### [Example 1] Preparation of Sulfide-Based Solid Electrolyte Including Chlorine and Iodine

A sulfide-based solid electrolyte of an argyrodite-type crystal structure was obtained in the same manner as in Comparative Example 1 except that 37.63 g of lithium sulfide (Li₂S) powder, 41.00 g of diphosphorus pentasulfide (P₂S₅) powder, 19.39 g of lithium chloride (LiCl) powder and 1.98 g of lithium iodide (LiI) powder were used. The composition, lithium ion conductivity and electronic conductivity characteristics of the obtained solid electrolyte are shown in Table 1 below.

### [Example 2] Preparation of Sulfide-Based Solid Electrolyte Including Chlorine and Bromine

A sulfide-based solid electrolyte of an argyrodite-type crystal structure was obtained in the same manner as in Comparative Example 1 except that 36.09 g of lithium sulfide (Li₂S) powder, 40.79 g of diphosphorus pentasulfide (P₂S₅ powder, 19.29 g of lithium chloride (LiCl) powder and 3.82 g of lithium bromide (LiBr) powder were used. The composition, lithium ion conductivity and electronic conductivity characteristics of the obtained solid electrolyte are shown in Table 1 below.

### [Example 3] Preparation of Sulfide-Based Solid Electrolyte Including Chlorine, Bromine and Iodine

A sulfide-based solid electrolyte of an argyrodite-type crystal structure was obtained in the same manner as in Comparative Example 1 except that 34.97 g of lithium sulfide (Li₂S) powder, 40.27 g of diphosphorus pentasulfide (P₂S₅) powder, 19.05 g of lithium chloride (LiCl) powder, 3.78 g of lithium bromide (LiBr) and 1.94 g of lithium iodide (LiI) powder were used. The composition, lithium ion conductivity and electronic conductivity characteristics of the obtained solid electrolyte are shown in Table 1 below.

### Comparative Example 2

The lithium ion conductivity and electronic conductivity obtained using a commercially available Li₂S—P₂S₅—LiCl-based solid electrolyte (Li₆₋ₓPS₅₋ₓCl₁₊ₓ) manufactured by company A are shown in Table 1.

### Comparative Example 3

The lithium ion conductivity and electronic conductivity obtained using a commercially available Li₂S—P₂S₅—LiCl-based solid electrolyte (Li₆₋ₓPS₅₋ₓCl₁₊ₓ) manufactured by company B are shown in Table 1.

TABLE 1

| | | | | Example 3 | | |
|---|---|---|---|---|---|---|
| | Com- | Example 1 | Example 2 | (ref. + LiI | Com- | Com- |
| | parative | (ref. + | (ref. + | 0.04 mol % + | parative | parative |
| | Example 1 | LiI 0.04 | LiBr 0.12 | LiBr 0.12 | Example 2 | Example 3 |
| | (ref.) | mol %) | mol %) | mol %) | Li₆₋ₓ | Li₆₋ₓ |
| | Li_{5.76}PS_{4.76} | Li_{5.80}PS_{4.76} | Li_{5.88}PS_{4.76} | Li_{5.92}PS_{4.76} | PS₅₋ₓ | PS₅₋ₓ |
| | Cl1.24 | Cl_{1.24}I_{0.04} | Cl_{1.24}Br_{0.12} | Cl_{1.24}I_{0.04}Br_{0.12} | Cl₁₊ₓ | Cl₁₊ₓ |
| Li2S | 38.81 | 37.63 | 36.09 | 34.97 | Solid | Solid |
| (wt %) | | | | | electrolyte | electrolyte |
| P2S5 | 41.54 | 41.00 | 40.79 | 40.27 | of | of |
| (wt %) | | | | | company A | company B |
| LiCl | 19.65 | 19.39 | 19.29 | 19.05 | | |
| (wt %) | | | | | | |
| LiI | | 1.98 | | 1.94 | | |
| (wt %) | | | | | | |
| LiBr | | | 3.82 | 3.78 | | |
| (wt %) | | | | | | |
| Li ion | 3.69 | 3.91 | 4.06 | 4.20 | 1.20 | 4.76 |
| con- | | | | | | |
| ductivity | | | | | | |
| (mS/cm) | | | | | | |
| electronic | 1.36 × 10⁻⁵ | 1.15 × 10⁻⁵ | 1.03 × 10⁻⁵ | 9.3 × 10⁻⁶ | 1.41 × 10⁻⁵ | 3.40 × 10⁻⁵ |
| con- | | | | | | |
| ductivity | | | | | | |
| (mS/cm) | | | | | | |

### Experimental Example

The current values and electronic conductivities measured at 1V of the solid electrolytes of Examples 1 to 3 and Comparative Examples 1 to 3 are shown in Table 2.

Electronic conductivity=(current value at 1V x solid electrolyte thickness)/solid electrolyte area

TABLE 2

| | Com- | | | | | | | | Com- | | Com- | |
|---|---|---|---|---|---|---|---|---|---|---|---|---|
| | parative | | Ex- | | Ex- | | Ex- | | parative | | parative | |
| | Example 1 | | ample 1 | | ample 2 | | ample 3 | | Example 2 | | Example 3 | |
| Measured | 76 | nA | 65 | nA | 58 | nA | 53 | nA | 80 | nA | 192 | nA |
| current | | | | | | | | | | | | |
| Solid | 0.235 | cm | 0.235 | cm | 0.235 | cm | 0.234 | cm | 0.234 | cm | 0.235 | cm |
| electrolyte | | | | | | | | | | | | |
| thickness | | | | | | | | | | | | |
| Solid | 1.327 | cm2 | 1.327 | cm2 | 1.327 | cm2 | 1.327 | cm2 | 1.327 | cm2 | 1.327 | cm2 |
| electrolyte | | | | | | | | | | | | |
| area | | | | | | | | | | | | |

| | | | | | | |
|---|---|---|---|---|---|---|
| Electronic | 1.36 × 10⁻⁵ | 1.15 × 10⁻⁵ | 1.03 × 10⁻⁵ | 9.3 × 10⁻⁶ | 1.41 × 10⁻⁵ | 3.40 × 10⁻⁵ |
| conductivity | | | | | | |
| (mS/cm) | | | | | | |

The Li₂S—P₂S₅-MCl-MX′-based sulfide-based solid electrolyte of the present invention has excellent lithium ion conductivity of 3.9 mS/cm or more and a low electronic conductivity of 1.4×10⁻⁵ mS/cm or less.

### INDUSTRIAL APPLICABILITY

A Li₂S—P₂S₅-MCl-MX′-based sulfide-based solid electrolyte of the present invention has excellent lithium ion conductivity and low electronic conductivity, so it can be used as an electrolyte for all-solid lithium secondary batteries.

1. A sulfide-based solid electrolyte, wherein the sulfide-based solid electrolyte is a Li₂S—P₂S₅-MCl-MX′ (X′ is a halogen other than Cl)-based sulfide-based solid electrolyte and has an argyrodite-type crystal structure,
wherein a molar ratio (Li/P) of lithium element (Li) to phosphorus element (P) is 5 or more and less than 6.2,
a sum of a molar ratio (S/P) of sulfur element (S) to phosphorus element (P) and a molar ratio (X/P) of halogen element (X) to phosphorus element (P) is 6 to 6.5, and
a molar ratio (X/S) of halogen element (X) to sulfur element (S) is 0.25 to 0.30.

2. The sulfide-based solid electrolyte according to claim 1, wherein chlorine and iodine are comprised as halogens.

3. The sulfide-based solid electrolyte according to claim 1, wherein a sum of the molar ratio (S/P) of sulfur element (S) to phosphorus element (P) and the molar ratio (X/P) of halogen element (X) to phosphorus element (P) is 6 to 6.2.

4. The sulfide-based solid electrolyte according to claim 1, wherein the sulfide-based solid electrolyte is a compound represented by Formula (1) below:
Li_{7-x-y}PS₆₋ₓX_{x+y} Formula (1)
where X is Cl and at least one halogen, other than Cl, selected from the group consisting of F, Br, I and combinations thereof,
0.8≤x≤1.5,0<y≤0.5, and
(x+y)/(6−x) is 0.25 to 0.30.

5. The sulfide-based solid electrolyte according to claim 4, wherein a molar ratio (Cl/P) of chlorine to phosphorus element (P) to a molar ratio (X/P) of halogen to phosphorus element (P) is 0.85 to 0.98.

6. The sulfide-based solid electrolyte according to claim 4, wherein a molar ratio (X/P) of halogen to phosphorus element (P) is 1.2 to 1.4.

7. The sulfide-based solid electrolyte according to claim 4, wherein (x+y)/(6−x) is 0.265 or more and less than 0.3.

8. A method of preparing a sulfide-based solid electrolyte, the method comprising:
a) mixing a raw material comprising a lithium-containing compound, a phosphorus-containing compound, a chlorine-containing compound and an iodine-containing compound while pulverizing the raw material; and
b) heat-treating a pulverized product, obtained by the mixing, at a temperature of 450° C. or higher and lower than 500° C. under a vacuum or inert atmosphere.

9. The method according to claim 8, wherein the raw material further comprises a bromine-containing compound.

10. The method according to claim 8, wherein the sulfide-based solid electrolyte is a Li₂S—P₂S₅-MCl-MX′ (X′ is a halogen other than Cl)-based sulfide-based solid electrolyte and has an argyrodite-type crystal structure,
wherein a molar ratio (Li/P) of lithium element (Li) to phosphorus element (P) is 5 or more and less than 6.2,
a sum of a molar ratio (S/P) of sulfur element (S) to phosphorus element (P) and a molar ratio (X/P) of halogen element (X) to phosphorus element (P) is 6 to 6.5, and
a molar ratio (X/S) of halogen element (X) to sulfur element (S) is 0.25 to 0.30.

11. The method according to claim 8, wherein the sulfide-based solid electrolyte is a compound represented by Formula (1) below:
Li_{7-x-y}PS₆₋ₓX_{x+y} Formula (1)
where X is Cl and at least one halogen, other than Cl, selected from the group consisting of F, Br, I and combinations thereof,
0.8≤x≤1.5,0<y≤0.5, and
(x+y)/(6−x) is 0.25 to 0.30.

12. An all-solid lithium secondary battery, comprising the sulfide-based solid electrolyte of claim 1 or a sulfide-based solid electrolyte prepared by the method of claim 8.
